(19) United States
(12) Patent Application Publication
(10) Pub. No.: US 2017/0227372 A1
(43) Pub. Date: Aug. 10, 2017

(54) Navigation Method and Terminal

(71) Applicant: Huawei Technologies Co., Ltd., Shenzhen (CN)

(72) Inventors: Xiaochen Chen, Shanghai (CN); Rui Sun, Shenzhen (CN)

(73) Assignee: Huawei Technologies Co., Ltd., Shenzhen (CN)

(21) Appl. No.: 15/515,062

(22) PCT Filed: Sep. 28, 2014
(86) PCT No.: PCT/CN2014/087668

§ 371 Date: Mar. 28, 2017

(51) Int. Cl. G01C 21/36

(52) U.S. Cl. CPC G01C 21/367

(57) ABSTRACT

A navigation method and a terminal, so as to reduce power consumption of an electronic device in a navigation process. A specific solution is that a terminal obtains start place information and destination information, and obtains information about a driving route determined according to the start place information and the destination information; the terminal obtains location information of the terminal in a moving process of the terminal; and the terminal turns off a screen of the terminal or adjusts screen brightness of the terminal from first screen brightness to second screen brightness when the location information of the terminal indicates that the terminal is on a first preset road section of the driving route, where the first screen brightness is greater than the second screen brightness. The present disclosure is applied in a navigation process and relates to the communications field.

### CROSS-REFERENCE TO RELATED APPLICATION

This application is a National Stage of International Patent Application No. PCT/CN2014/087668, filed on Sep. 28, 2014, which is hereby incorporated by reference in its entirety.

### TECHNICAL FIELD

The present disclosure relates to the communications field, and in particular, to a navigation method and a terminal.

### BACKGROUND

With continuous development of science and technology, navigation software has been widely used in people's daily life. The navigation software is an application that a Global Positioning System (GPS) or another positioning system is used and an instruction is provided on a map by checking a current geographical location of a user.

It is well known that, in the prior art, after a user starts navigation, an electronic device keeps providing voice and interface prompt for a driving route in a driving process of the user. However, when the user drives on a viaduct or the like, the user only requires to drive along the viaduct before arriving at a specific exit, and does not require the electronic device to provide voice and interface prompt for a driving route. Therefore, if the electronic device keeps providing voice and interface prompt for the driving route in the driving process of the user, power consumption of the electronic device is relatively high.

### SUMMARY

The present disclosure provides a navigation method and a terminal, so as to reduce power consumption of an electronic device in a navigation process.

To achieve the foregoing objective, the following technical solutions are used in the present disclosure.

According to a first aspect of the present disclosure, a navigation method is provided, including obtaining, by a terminal, start place information and destination information, and obtaining information about a driving route determined according to the start place information and the destination information; obtaining, by the terminal, location information of the terminal in a moving process of the terminal; and turning off, by the terminal, a screen of the terminal or adjusting screen brightness of the terminal from first screen brightness to second screen brightness when the location information of the terminal indicates that the terminal is on a first preset road section of the driving route, where the first screen brightness is greater than the second screen brightness.

With reference to the first aspect, in a first possible implementation manner, when the terminal turns off the screen of the terminal or adjusts the screen brightness of the terminal from the first screen brightness to the second screen brightness, the terminal stops providing voice prompt.

With reference to the first aspect or the first possible implementation manner of the first aspect, in a second possible implementation manner, the turning off, by the terminal, a screen of the terminal or adjusting screen brightness of the terminal from first screen brightness to second screen brightness when the location information of the terminal indicates that the terminal is on a first preset road section of the driving route includes turning off, by the terminal, the screen of the terminal or adjusting the screen brightness of the terminal from the first screen brightness to the second screen brightness when the terminal determines that the location information of the terminal is a start location of the first preset road section.

With reference to the first aspect, the first possible implementation manner of the first aspect, or the second possible implementation manner of the first aspect, in a third possible implementation manner, the method further includes turning on, by the terminal, the screen of the terminal or performing display according to the first screen brightness when the location information of the terminal indicates that the terminal is not in the first preset road section.

With reference to the third possible implementation manner of the first aspect, in a fourth possible implementation manner, the turning on, by the terminal, the screen of the terminal or performing display according to the first screen brightness when the location information of the terminal indicates that the terminal is not in the first preset road section includes turning on, by the terminal, the screen of the terminal or performing display according to the first screen brightness when the terminal determines that the location information of the terminal is an end location of the first preset road section.

With reference to the first aspect, or the first possible implementation manner of the first aspect to the fourth possible implementation manner of the first aspect, in a fifth possible implementation manner, the first preset road section is preset by a user; or the first preset road section is determined by the terminal according to a historical driving route and is preconfigured in the terminal; or the first preset road section is determined by the terminal according to road section information sent by the navigation server.

With reference to the first aspect, or the first possible implementation manner of the first aspect to the fifth possible implementation manner of the first aspect, in a sixth possible implementation manner, before the turning off, by the terminal, a screen of the terminal or adjusting screen brightness of the terminal from first screen brightness to second screen brightness when the location information of the terminal indicates that the terminal is on a first preset road section of the driving route, the method further includes receiving, by the terminal, a geographical location that is on the driving route and is entered by the user or sent by the navigation server and in which navigation requires to be started; and starting, by the terminal, navigation when the terminal determines that the location information of the terminal is the geographical location in which navigation requires to be started, or when the terminal passes through, in a moving direction of the terminal, the geographical location in which navigation requires to be started.

According to a second aspect of the present disclosure, a terminal is provided, including a processor and a positioning chip, where the processor is configured to obtain start place information and destination information, and obtain information about a driving route determined according to the start place information and the destination information; the positioning chip is configured to obtain location information of the terminal in a moving process of the terminal; and the processor is further configured to turn off a screen of the terminal or adjust screen brightness of the terminal from first screen brightness to second screen brightness when the location information of the terminal obtained by the positioning chip indicates that the terminal is on a first preset road section of the driving route, where the first screen brightness is greater than the second screen brightness.

With reference to the second aspect, in a first possible implementation manner, the terminal further includes an audio processor; and the audio processor stops providing voice prompt when the processor turns off the screen of the terminal or adjusts the screen brightness of the terminal from the first screen brightness to the second screen brightness.

With reference to the second aspect or the first possible implementation manner of the second aspect, in a second possible implementation manner, the processor is configured to turn off the screen of the terminal or adjust the screen brightness of the terminal from the first screen brightness to the second screen brightness when determining that the location information of the terminal is a start location of the first preset road section.

With reference to the second aspect, the first possible implementation manner of the second aspect, or the second possible implementation manner of the second aspect, in a third possible implementation manner, the processor is further configured to turn on the screen of the terminal or perform display according to the first screen brightness when the location information of the terminal obtained by the positioning chip indicates that the terminal is not in the first preset road section.

With reference to the third possible implementation manner of the second aspect, in a fourth possible implementation manner, the processor is configured to turn on the screen of the terminal or perform display according to the first screen brightness when determining that the location information of the terminal is an end location of the first preset road section.

With reference to the second aspect, or the first possible implementation manner of the second aspect to the fourth possible implementation manner of the second aspect, in a fifth possible implementation manner, the first preset road section is preset by a user; or the first preset road section is determined by the terminal according to a historical driving route and is preconfigured in the terminal; or the first preset road section is determined by the terminal according to road section information sent by the navigation server.

With reference to the second aspect, or the first possible implementation manner of the second aspect to the fifth possible implementation manner of the second aspect, in a sixth possible implementation manner, the terminal further includes a receiver; the receiver is configured to, before the processor turns off the screen of the terminal or adjusts the screen brightness of the terminal from the first screen brightness to the second screen brightness, receive a geographical location that is on the driving route and is entered by the user or sent by the navigation server and in which navigation requires to be started; and the processor is further configured to start navigation when determining that the location information of the terminal is the geographical location in which navigation requires to be started, or when the terminal passes through, in a moving direction of the terminal, the geographical location in which navigation requires to be started.

According to the navigation method and the terminal provided in the present disclosure, the terminal obtains start place information and destination information, and obtains information about a driving route determined according to the start place information and the destination information. After obtaining location information of the terminal in a moving process of the terminal, the terminal turns off a screen of the terminal or adjusts screen brightness of the terminal from first screen brightness to second screen brightness when determining that the location information of the terminal indicates that the terminal is on a first preset road section of the driving route. The first screen brightness is greater than the second screen brightness. When the terminal moves to the first preset road section, the screen of the terminal is turned off or the screen brightness of the terminal is reduced, so that power consumption of the terminal is reduced.

### BRIEF DESCRIPTION OF DRAWINGS

To describe the technical solutions in the embodiments of the present disclosure more clearly, the following briefly describes the accompanying drawings required for describing the embodiments or the prior art. The accompanying drawings in the following description show merely some embodiments of the present disclosure, and a person of ordinary skill in the art may still derive other drawings from these accompanying drawings without creative efforts.

FIG. 1 is a schematic flowchart of a navigation method according to an embodiment of the present disclosure;

FIG. 2 is a schematic flowchart of a navigation method according to another embodiment of the present disclosure;

FIG. 3 is a schematic diagram of an address entering interface according to an embodiment of the present disclosure;

FIG. 4 is a schematic diagram of a driving route according to an embodiment of the present disclosure;

FIG. 5 is a schematic compositional diagram of a terminal according to another embodiment of the present disclosure;

FIG. 6 is a schematic compositional diagram of another terminal according to another embodiment of the present disclosure; and

FIG. 7 is a schematic compositional diagram of another terminal according to another embodiment of the present disclosure.

### DESCRIPTION OF EMBODIMENTS

The following clearly and completely describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

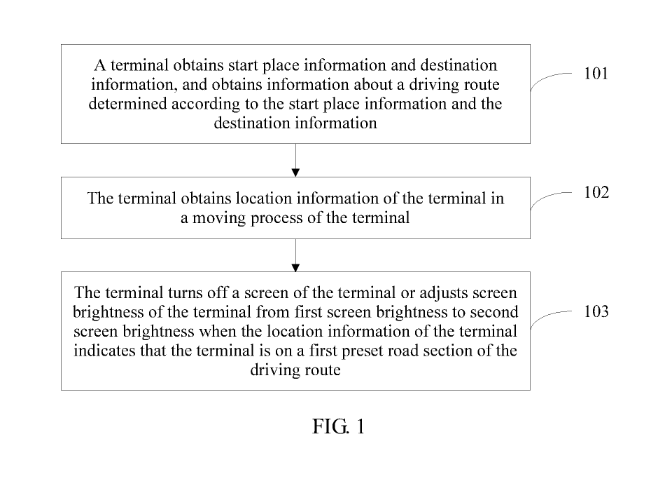

An embodiment of the present disclosure provides a navigation method. As shown in FIG. 1, the method may include the following steps.

101. A terminal obtains start place information and destination information, and obtains information about a driving route determined according to the start place information and the destination information.

When a user uses navigation software for navigation, the user may enter the start place information and the destination information to the terminal on which the navigation software is installed, or the user may enter only the destination information and select a current location as a start place. The current location is a terminal location that is positioned by the terminal using a positioning chip. In this case, the terminal may obtain the corresponding start place information and destination information, and after obtaining the start place information and the destination information, the terminal further requires to obtain the information about the driving route determined according to the start place information and the destination information.

102. The terminal obtains location information of the terminal in a moving process of the terminal.

After obtaining the information about the driving route determined according to the start place information and the destination information, the terminal may present the information about the driving route for the user. In this way, the user may move along the driving route corresponding to the information, presented by the terminal, about the driving route. In a moving process of the user, the terminal also moves correspondingly. In this case, the terminal may obtain the location information of the terminal in a moving process of the terminal.

Certainly, one or more pieces of information about a driving route may be determined according to the start place information and the destination information. When information about multiple driving routes is determined according to the start place information and the destination information, the terminal may present all the obtained information about the multiple driving routes for the user, so that the user performs selection. After the user selects a driving route that is corresponding to information about the driving route and according to which navigation is performed, the terminal finally presents only the information about the selected driving route for the user. In this way, the user may move along the driving route corresponding to the information about the finally selected driving route.

The terminal may obtain the location information of the terminal using hardware and corresponding software and using a GPS of the United States, a BeiDou positioning system of China, a Global Satellite Positioning System (GLONASS) of Russia, or the like.

That is, the terminal may determine a current location of the terminal using the foregoing positioning systems, and determine the location information of the terminal using different locations of the terminal at different times.

103. The terminal turns off a screen of the terminal or adjusts screen brightness of the terminal from first screen brightness to second screen brightness when the location information of the terminal indicates that the terminal is on a first preset road section of the driving route.

The first screen brightness is greater than the second screen brightness. To reduce power consumption of the terminal, in the moving process of the terminal, the terminal may determine whether the obtained location information of the terminal indicates that the terminal is on the first preset road section of the driving route, that is, a road section in which navigation prompt is not provided, and when determining that the location information of the terminal indicates that the terminal is on the road section that is on the driving route and in which the navigation prompt is not provided, the terminal may turn off the screen of the terminal or adjust the screen brightness of the terminal from the first screen brightness to the second screen brightness (that is, turns off the screen of the terminal or reduces the screen brightness of the terminal) using a geofencing feature (the geofencing feature is that the terminal automatically triggers a corresponding operation when the location information of the terminal is a preset geographical location).

It should be noted that the terminal in this embodiment of the present disclosure may refer to an electronic device with a navigation function, such as a mobile phone. The terminal is not limited herein in this embodiment of the present disclosure.

According to the navigation method provided in this embodiment of the present disclosure, a terminal obtains start place information and destination information, and obtains information about a driving route determined according to the start place information and the destination information. After obtaining location information of the terminal in a moving process of the terminal, the terminal turns off a screen of the terminal or adjusts screen brightness of the terminal from first screen brightness to second screen brightness when determining that the location information of the terminal indicates that the terminal is on a first preset road section of the driving route. The first screen brightness is greater than the second screen brightness. When the terminal moves to the first preset road section, the screen of the terminal is turned off or the screen brightness of the terminal is reduced, so that power consumption of the terminal is reduced.

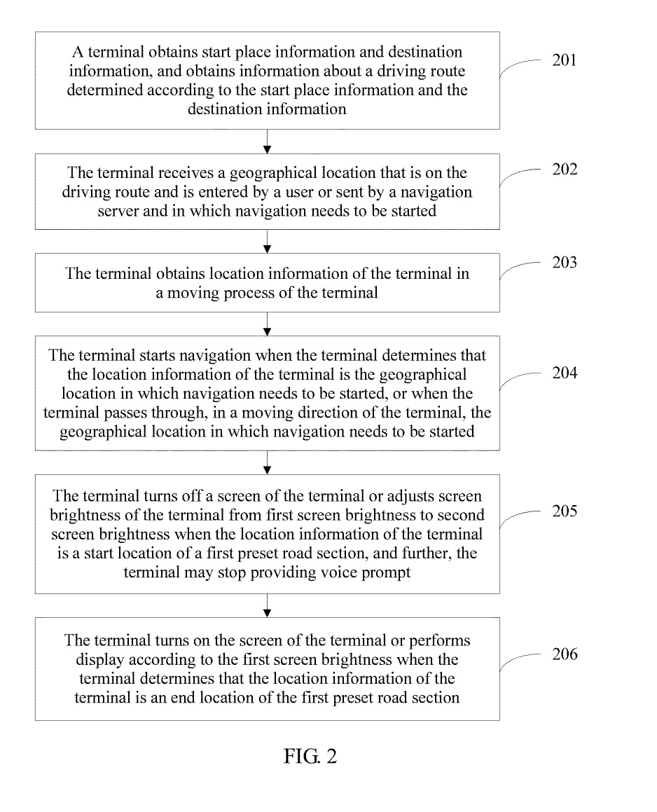

Another embodiment of the present disclosure provides a navigation method. As shown in FIG. 2, the method may include the following steps.

201. A terminal obtains start place information and destination information, and obtains information about a driving route determined according to the start place information and the destination information.

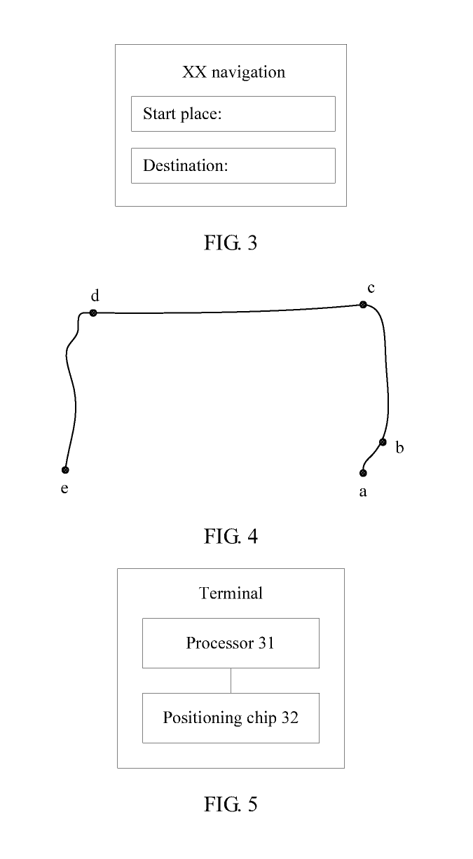

When a user uses navigation software for navigation, the user may enter the start place information and the destination information to a terminal on which the navigation software is installed, and the user may enter the start place information and the destination information into the terminal in an entering manner of character entering. For example, the user enters, in a character entering manner, the start place information and the destination information to a corresponding location on an address entering interface that is displayed on a display of the terminal and that is shown in FIG. 3, or the user may directly select geographical locations of the start place information and the destination information from an electronic map displayed on a display of the terminal. In this case, the terminal may respectively use, as the start place information and the destination information according to triggering of the user, address information of the geographical locations that are of the start place information and the destination information and that are selected by the user. Certainly, another entering manner may be used. An entering manner of the start place information and the destination information is not limited herein in this embodiment of the present disclosure. An entering manner that is used may be selected according to a requirement in an actual application scenario. Certainly, the user may enter only the destination information on the address entering interface displayed on the display of the terminal, and select a current location as a start place. The current location is a terminal location that is positioned by the terminal using a positioning chip. In the foregoing manner, the terminal may obtain the start place information and the destination information, and after obtaining the start place information and the destination information, the terminal further requires to obtain the information about the driving route determined according to the start place information and the destination information.

The information about the driving route may be obtained in any one of the following manners.

Manner 1: After the terminal obtains the start place information and the destination information, the terminal may send the start place information and the destination information to a navigation server, so that the navigation server determines the information about the driving route according to the received start place information and destination information, and sends the determined information about the driving route to the terminal. In this case, the terminal may obtain the information, sent by the navigation server, about the driving route.

Manner 2: After the terminal obtains the start place information and the destination information, when navigation software of the terminal is in an offline state (for example, navigation of a car or a data network of a mobile phone is disabled), the terminal may directly determine the information about the driving route according to the start place information and the destination information using a pre-downloaded offline map.

202. The terminal receives a geographical location that is on the driving route and is entered by a user or sent by a navigation server and in which navigation requires to be started.

After the terminal obtains the information about the driving route determined according to the start place information and the destination information, and the information about the driving route is presented for the user on the display of the terminal, the user may determine, according to a require of the user, the geographical location that is on the driving route and in which navigation requires to be started, and enter, to the terminal, the determined geographical location that is on the driving route and in which navigation requires to be started. In this case, the terminal may receive the geographical location that is entered by the user and in which navigation requires to be started.

It should be noted that, in this embodiment of the present disclosure, the geographical location in which navigation requires to be started may be a geographical location that is corresponding to the start place information and is entered by the user, or may be a user-defined geographical location or another geographical location on the driving route. This is not limited in this embodiment of the present disclosure.

After the terminal receives the information about the driving route, the terminal may further present the information about the driving route for the user using the display of the terminal. In this way, the user may move along the driving route corresponding to the information, presented by the terminal, about the driving route. When the user moves along the driving route, the terminal also moves correspondingly. In a moving process of the terminal, the terminal may detect a current location of the terminal, to obtain the location information of the terminal. To reduce power consumption of the terminal and provide better user experience, when the terminal moves to a corresponding geographical location, the terminal may perform corresponding operations using a geofencing feature (the geofencing feature is that the terminal automatically triggers a corresponding operation when the location information of the terminal is a preset geographical location) according to the detected location information and the geographical location that is on the driving route and is received in step 202 and in which navigation requires to be started. The following step 204 to step 206 are performed.

203. The terminal obtains location information of the terminal in a moving process of the terminal.

In the moving process of the terminal, the positioning chip of the terminal may detect the location information of the terminal in real time, and send the detected location information of the terminal to a processor of the terminal, so that the terminal obtains the location information of the terminal.

204. The terminal starts navigation when the terminal determines that the location information of the terminal is the geographical location in which navigation requires to be started, or when the terminal passes through, in a moving direction of the terminal, the geographical location in which navigation requires to be started.

After the terminal obtains the location information of the terminal, to provide better user experience, the terminal may determine whether the obtained location information of the terminal is the geographical location in which navigation requires to be started, and when determining that the obtained location information of the terminal is the geographical location in which navigation requires to be started, the terminal triggers the navigation software to start navigation. After the navigation software starts navigation, the terminal may display moving information of the terminal, an electronic map, and the information about the driving route using a display interface of the navigation software, and may provide corresponding voice prompt according to the moving information. The moving information of the terminal is determined by the terminal according to the location information of the terminal after the terminal obtains the location information of the terminal, and the moving information may include a traveling route (including a direction, a location, a distance, and the like), a speed, and the like.

After the terminal triggers the navigation software to start navigation, the positioning chip of the terminal may continue to detect the location information of the terminal in real time, and send the detected location information of the terminal to the processor of the terminal, so that the terminal obtains the location information of the terminal. In this case, to reduce power consumption of the terminal, after obtaining the location information of the terminal, the terminal may determine whether the location information of the terminal indicates that the terminal is on a first preset road section of the driving route, and the terminal turns off a screen of the terminal or adjusts screen brightness of the terminal from first screen brightness to second screen brightness when determining that the location information of the terminal indicates that the terminal is on the first preset road section. The first screen brightness is greater than the second screen brightness. Further, voice prompt may be stopped when the terminal turns off the screen of the terminal or adjusts the screen brightness of the terminal from the first screen brightness to the second screen brightness. Certainly, voice prompt may be provided when the terminal turns off the screen of the terminal or adjusts the screen brightness of the terminal from the first screen brightness to the second screen brightness.

The first preset road section in the present disclosure may be preset by the user, or may be determined by the terminal according to a historical driving route and preconfigured in the terminal, or may be determined according to road section information sent by the navigation server.

When the first preset road section is preset by the user, after the terminal obtains the information about the driving route determined according to the start place information and the destination information, and the information about the driving route is presented for the user using the display of the terminal, the user may determine, according to a require of the user, a road section that is on the driving route and in which navigation prompt is not provided, that is, the first preset road section, and enter road section information (which may include start location information and end location information of the first preset road section) of the determined first preset road section on the driving route into the terminal. In this case, the terminal may receive the road section information, entered by the user, of the first preset road section on the driving route.

When the first preset road section is determined by the terminal according to the historical driving route and preconfigured in the terminal, the terminal may obtain the first preset road section by means of automatic learning and save the first preset road section in the terminal. In a possible implementation manner, an automatic learning process of the terminal may be that when determining that a quantity of times the user drives on a specific driving route exceeds a preset threshold, the terminal determines the driving route as the first preset road section according to the historical driving route, and saves the first preset road section in the terminal. Specific information of the first preset road section stored in the terminal may be the start location information and the end location information of the first preset road section.

When the first preset road section is determined by the terminal according to the road section information sent by the navigation server, a specific process of obtaining the first preset road section may be that when the navigation server determines the information about the driving route according to the start place information and the destination information, the navigation server may determine, according to a feature of the driving route corresponding to the determined information about the driving route, a road section that is on the driving route and in which navigation prompt is not provided, that is, the first preset road section, and send road section information (which may include start location information and end location information of the first preset road section) of the determined first preset road section on the driving route to the terminal. In this case, the terminal determines the first preset road section according to the received road section information.

For example, the first preset road section in this embodiment of the present disclosure may be a road section between two cities, or may be a road section such as a viaduct or an expressway. When the first preset road section is a road section between two cities, a start location of the first preset road section and an end location of the first preset road section may be separately central points of the two cities, or may be boundary points of the two cities. For example, the first preset road section is a road section such as a viaduct or an expressway, a start location of the first preset road section and an end location of the first preset road section may be separately an entrance and an exit of the viaduct or the expressway.

In this embodiment of the present disclosure, that the terminal turns off a screen of the terminal or adjusts screen brightness of the terminal from first screen brightness to second screen brightness when the location information of the terminal indicates that the terminal is on the first preset road section may include the following step 205.

205. The terminal turns off a screen of the terminal or adjusts screen brightness of the terminal from first screen brightness to second screen brightness when the location information of the terminal is a start location of a first preset road section, and further, the terminal may stop providing voice prompt.

After the terminal obtains the location information of the terminal, the terminal may determine whether the currently received location information of the terminal is the start location of the first preset road section, and when determining that the location information of the terminal is the start location of the first preset road section, determine that the terminal is on the first preset road section of the driving route, that is, the road section in which voice prompt is not provided. In this case, the terminal may turn off the screen of the terminal or adjust the screen brightness of the terminal from the first screen brightness to the second screen brightness, so that the terminal turns off the screen of the terminal or reduces the screen brightness of the terminal from a geographical location (that is, the start location of the first preset road section) corresponding to the location information, and optionally, the terminal may stop providing voice prompt.

After the terminal turns off the screen of the terminal or reduces the screen brightness of the terminal, the positioning chip of the terminal may continue to detect the location information of the terminal in real time, and send the detected location information of the terminal to the processor of the terminal, so that the terminal obtains the location information of the terminal. Certainly, to further reduce the power consumption of the terminal, the positioning chip of the terminal may not send the detected location information of the terminal to the processor of the terminal before detecting that the location information of the terminal is an end location of a silent road section.

After the terminal turns off the screen of the terminal or reduces the screen brightness of the terminal, the positioning chip of the terminal still continues to detect the location information of the terminal in real time, and sends the detected location information of the terminal to the processor of the terminal in real time, or sends the detected location information of the terminal to the processor of the terminal when the detected location information of the terminal is the end location of the silent road section, so that the terminal obtains the location information of the terminal. In this case, after obtaining the location information of the terminal, the terminal may determine whether the obtained location information of the terminal indicates that the terminal is not in the first preset road section of the driving route, and the terminal turns on the screen of the terminal or performs display according to the first screen brightness when determining that the location information of the terminal indicates that the terminal is not in the first preset road section of the driving route. That the terminal turns on the screen of the terminal or performs display according to the first screen brightness when the location information of the terminal indicates that the terminal is not in the first preset road section of the driving route may include the following step 206.

206. The terminal turns on the screen of the terminal or performs display according to the first screen brightness when the terminal determines that the location information of the terminal is an end location of the first preset road section.

After the terminal obtains the location information of the terminal, the terminal may determine whether the currently obtained location information of the terminal is the end location of the first preset road section, and when determining that the currently obtained location information of the terminal is the end location of the first preset road section, determine that the terminal is not in the first preset road section of the driving route. In this case, the terminal may turn on the screen of the terminal or perform display according to the first screen brightness, so that from the geographical location (that is, the end location of the first preset road section) corresponding to the location information, the terminal continues to perform display on an interface or perform normal display according to the first screen brightness, and provides voice prompt.

Certainly, in an actual application scenario, the user may set multiple first preset road sections according to a require of the user, or the navigation server sets multiple first preset road sections according to an actual situation of a driving route, and in all the multiple first preset road sections, the terminal turns off the screen of the terminal or reduces the screen brightness of the terminal. Alternatively, further, when the screen of the terminal is turned off or the screen brightness of the terminal is reduced, no voice prompt is provided, and in a road section other than the multiple first preset road sections, the terminal continues to perform display on an interface or perform normal display according to the first screen brightness, and provides voice prompt (for corresponding to processing of the terminal in different road sections, refer to step 205 and step 206) until the user moves to a destination.

To facilitate understanding by a person skilled in the art, a specific implementation process of the present disclosure is described using an example herein in this embodiment of the present disclosure.

When a user moves from a place a to another place and requires to use navigation software for navigation, the user may enter the start place a (the start place a may not be entered into a terminal by the user but is a current location positioned by a positioning chip of the terminal) and the destination e into the terminal using an entering device (a keyboard, a touchscreen, a stylus, a gesture identification and entering device, or the like) of the terminal. After the terminal obtains the start place a and the destination e entered by the user, the terminal may send the start place a and the destination e to a navigation server, so that the navigation server determines a driving route according to the start place a and the destination e, and sends information corresponding to the determined driving route to a receiver of the terminal. For example, the driving route determined by the navigation server is shown in FIG. 4. The receiver of the terminal receives a geographical location that is entered by the user and in which navigation requires to be started, and a first preset road section is preset by the user. For example, the geographical location that is entered by the user and in which navigation requires to be started is a point b (certainly, the point b may overlap the point a, that is, the geographical location that is entered by the user and in which navigation requires to be started is the start place a), a start location of the first preset road section preset by the user is a point c, and an end location is a point d.

In a process in which the user moves from the point a along the driving route corresponding to the information about the driving route, a positioning chip of the terminal obtains current location information of the terminal by means of interaction with a positioning system, and sends the obtained current location information of the terminal to a processor of the terminal (preferably, when the user moves to the first preset road section, that is, a road section cd, the positioning chip of the terminal may not send the detected location information of the terminal to the processor of the terminal, and certainly, when detecting that the location information of the terminal is the point d, the positioning chip of the terminal continues to send the location information of the terminal to the processor the terminal). After the processor of the terminal receives the location information of the terminal, when determining that the currently received location information of the terminal is the point b, the processor of the terminal triggers the navigation software of the terminal to start navigation. In a process in which the user continues to move along the driving route, when the processor of the terminal determines that a currently received location of the terminal is the point c, the terminal turns off a screen of the terminal or adjusts screen brightness of the terminal from first screen brightness to second screen brightness, that is, turns off the screen of the terminal or reduces the screen brightness of the terminal from the point c, and optionally, voice prompt is stopped. Certainly, the user may still continue to move along the driving route, and in a process in which the user continues to move along the driving route, the processor of the terminal may determine whether the user has moved out of the first preset road section. That is, when the processor of the terminal determines that the currently received location information of the terminal is the point d, the terminal turns on the screen of the terminal or performs display according to the first screen brightness, so as to continue to perform display on an interface or perform normal display according to the first screen brightness from the point d, provide voice prompt, and stop navigation when the user moves to the destination e.

According to the navigation method provided in this embodiment of the present disclosure, a terminal obtains start place information and destination information, and obtains information about a driving route determined according to the start place information and the destination information. After obtaining location information of the terminal in a moving process of the terminal, the terminal turns off a screen of the terminal or adjusts screen brightness of the terminal from first screen brightness to second screen brightness when determining that the location information of the terminal indicates that the terminal is on a first preset road section of the driving route. The first screen brightness is greater than the second screen brightness. When the terminal moves to the first preset road section, the screen of the terminal is turned off or the screen brightness of the terminal is reduced, so that power consumption of the terminal is reduced.

In addition, when the screen of the terminal is turned off or the screen brightness of the terminal is adjusted from the first screen brightness to the second screen brightness, voice prompt is stopped. Therefore, the power consumption of the terminal is further reduced. When the terminal determines that the location information of the terminal is a geographical location that is on the driving route and in which navigation requires to be started, the terminal automatically starts navigation. In comparison with a manner of manually triggering start of navigation in the prior art, better user experience is provided.

Another embodiment of the present disclosure provides a terminal. As shown in FIG. 5, the terminal may include a processor 31 and a positioning chip 32.

The processor 31 is configured to obtain start place information and destination information, and obtain information about a driving route determined according to the start place information and the destination information.

The positioning chip 32 is configured to obtain location information of the terminal in a moving process of the terminal.

The processor 31 is further configured to turn off a screen of the terminal or adjust screen brightness of the terminal from first screen brightness to second screen brightness when the location information of the terminal obtained by the positioning chip 32 indicates that the terminal is on a first preset road section of the driving route. The first screen brightness is greater than the second screen brightness.

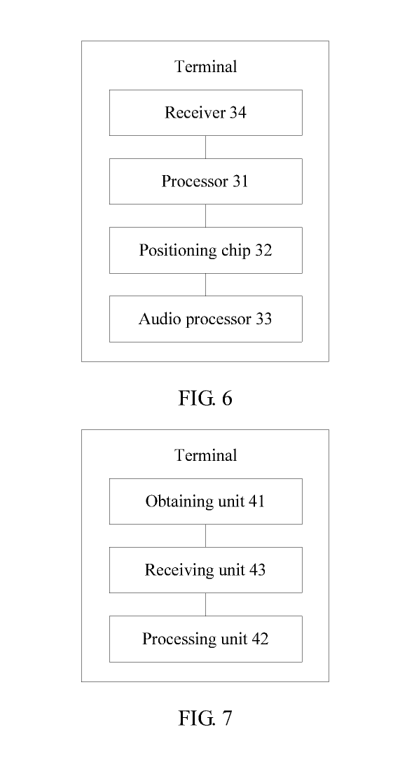

Further, as shown in FIG. 6, the terminal may further include an audio processor 33.

The audio processor 33 stops providing voice prompt when the processor 31 turns off the screen of the terminal or adjusts the screen brightness of the terminal from the first screen brightness to the second screen brightness.

Further, the processor 31 is configured to turn off the screen of the terminal or adjust the screen brightness of the terminal from the first screen brightness to the second screen brightness when determining that the location information of the terminal is a start location of the first preset road section.

Further, the processor 31 is further configured to turn on the screen of the terminal or perform display according to the first screen brightness when the location information of the terminal obtained by the positioning chip 32 indicates that the terminal is not in the first preset road section.

Further, the processor 31 is configured to turn on the screen of the terminal or perform display according to the first screen brightness when determining that the location information of the terminal is an end location of the first preset road section.

Further, the first preset road section is preset by a user; or the first preset road section is determined by the terminal according to a historical driving route and is preconfigured in the terminal; or the first preset road section is determined by the terminal according to road section information sent by the navigation server.

Further, the terminal may further include a receiver 34.

The receiver 34 is configured to, before the processor 31 turns off the screen of the terminal or adjusts the screen brightness of the terminal from the first screen brightness to the second screen brightness, receive a geographical location that is on the driving route and is entered by the user or sent by the navigation server and in which navigation requires to be started.

The processor 31 is further configured to start navigation when determining that the location information of the terminal is the geographical location in which navigation requires to be started, or when the terminal passes through, in a moving direction of the terminal, the geographical location in which navigation requires to be started.

It should be noted that, for specific working processes of function modules of the terminal provided in this embodiment of the present disclosure, refer to specific descriptions of corresponding processes in the method embodiments, and details are not described herein in this embodiment of the present disclosure.

The terminal provided in this embodiment of the present disclosure obtains start place information and destination information, and obtains information about a driving route determined according to the start place information and the destination information. After obtaining location information of the terminal in a moving process of the terminal, the terminal turns off a screen of the terminal or adjusts screen brightness of the terminal from first screen brightness to second screen brightness when determining that the location information of the terminal indicates that the terminal is on a first preset road section of the driving route. The first screen brightness is greater than the second screen brightness. When the terminal moves to the first preset road section, the screen of the terminal is turned off or the screen brightness of the terminal is reduced, so that power consumption of the terminal is reduced.

In addition, when the screen of the terminal is turned off or the screen brightness of the terminal is adjusted from the first screen brightness to the second screen brightness, voice prompt is stopped. Therefore, the power consumption of the terminal is further reduced. When the terminal determines that the location information of the terminal is a geographical location that is on the driving route and in which navigation requires to be started, the terminal automatically starts navigation. In comparison with a manner of manually triggering start of navigation in the prior art, better user experience is provided.

Another embodiment of the present disclosure provides a terminal. As shown in FIG. 7, the terminal may include an obtaining unit 41 and a processing unit 42.

The obtaining unit 41 is configured to obtain start place information and destination information, obtain information about a driving route determined according to the start place information and the destination information, and obtain location information of the terminal in a moving process of the terminal.

The processing unit 42 is configured to turn off a screen of the terminal or adjust screen brightness of the terminal from first screen brightness to second screen brightness when the location information of the terminal obtained by the obtaining unit 41 indicates that the terminal is on a first preset road section of the driving route. The first screen brightness is greater than the second screen brightness.

Further, the processing unit 42 is further configured to stop providing voice prompt when the processing unit 42 turns off the screen of the terminal or adjusts the screen brightness of the terminal from the first screen brightness to the second screen brightness.

Further, the processing unit 42 is configured to turn off the screen of the terminal or adjust the screen brightness of the terminal from the first screen brightness to the second screen brightness when determining that the location information of the terminal is a start location of the first preset road section.

Further, the processing unit 42 is further configured to turn on the screen of the terminal or perform display according to the first screen brightness when the location information of the terminal indicates that the terminal is not in the first preset road section.

Further, the processing unit 42 is configured to turn on the screen of the terminal or perform display according to the first screen brightness when determining that the location information of the terminal is an end location of the first preset road section.

Further, the first preset road section is preset by a user; or the first preset road section is determined by the terminal according to a historical driving route and is preconfigured in the terminal; or the first preset road section is determined by the terminal according to road section information sent by the navigation server.

Further, the terminal further includes a receiving unit 43.

The receiving unit 43 is configured to, when the location information of the terminal indicates that the terminal is on the first preset road section of the driving route, and before the processing unit 42 turns off the screen of the terminal or adjusts the screen brightness of the terminal from the first screen brightness to the second screen brightness, receive a geographical location that is on the driving route and is entered by the user or sent by the navigation server and in which navigation requires to be started.

The processing unit 42 is further configured to start navigation when determining that the location information of the terminal is the geographical location in which navigation requires to be started, or when the terminal passes through, in a moving direction of the terminal, the geographical location in which navigation requires to be started.

It should be noted that, for specific working processes of function modules of the terminal provided in this embodiment of the present disclosure, refer to specific descriptions of corresponding processes in the method embodiments, and details are not described herein in this embodiment of the present disclosure.

The terminal provided in this embodiment of the present disclosure obtains start place information and destination information, and obtains information about a driving route determined according to the start place information and the destination information. After obtaining location information of the terminal in a moving process of the terminal, the terminal turns off a screen of the terminal or adjusts screen brightness of the terminal from first screen brightness to second screen brightness when determining that the location information of the terminal indicates that the terminal is on a first preset road section of the driving route. The first screen brightness is greater than the second screen brightness. When the terminal moves to the first preset road section, the screen of the terminal is turned off or the screen brightness of the terminal is reduced, so that power consumption of the terminal is reduced.

In addition, when the screen of the terminal is turned off or the screen brightness of the terminal is adjusted from the first screen brightness to the second screen brightness, voice prompt is stopped. Therefore, the power consumption of the terminal is further reduced. When the terminal determines that the location information of the terminal is a geographical location that is on the driving route and in which navigation requires to be started, the terminal automatically starts navigation. In comparison with a manner of manually triggering start of navigation in the prior art, better user experience is provided.

Based on the foregoing descriptions about implementation manners, a person skilled in the art may clearly understand that, for the purpose of convenient and brief description, division of the foregoing function modules is taken as an example for illustration. In actual application, the foregoing functions may be allocated to different modules and implemented according to a requirement, that is, an inner structure of an apparatus is divided into different function modules to implement all or part of the functions described above.

In the several embodiments provided in this application, it should be understood that the disclosed apparatus and method may be implemented in other manners. For example, the described apparatus embodiment is merely an example. For example, the module or unit division is merely logical function division and may be other division in actual implementation. For example, multiple units or components may be combined or integrated into another apparatus, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may be one or more physical units, may be located in one place, or may be distributed in different places. Some or all of the units may be selected according to actual requires to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a readable storage medium. Based on such an understanding, the technical solutions of the present disclosure essentially, or the part contributing to the prior art, or all or some of the technical solutions may be implemented in a form of a software product. The software product is stored in a storage medium and includes several instructions for instructing a device (which may be a single-chip microcomputer, a chip, or the like) or a processor to perform all or some of the steps of the methods described in the embodiments of the present disclosure. The foregoing storage medium includes any medium that can store program code, such as a universal serial bus (USB) flash drive, a removable hard disk, a read-only memory (ROM), a random access memory (RAM), a magnetic disk, or an optical disc.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A navigation method, comprising:
obtaining, by a terminal, start place information and destination information;
obtaining, by the terminal, information about a driving route determined according to the start place information and the destination information;
obtaining, by the terminal, location information of the terminal in a moving process of the terminal; and
adjusting screen brightness of the terminal from first screen brightness to second screen brightness when the location information of the terminal indicates that the terminal is on a first preset road section of the driving route,
wherein the first screen brightness is greater than the second screen brightness.

2. The method according to claim 1, wherein the terminal stops providing voice prompt when the terminal turns off the screen of the terminal or adjusts the screen brightness of the terminal from the first screen brightness to the second screen brightness.

3. The method according to claim 1, wherein turning off, by the terminal, the screen of the terminal or adjusting the screen brightness of the terminal from first screen brightness to second screen brightness when the location information of the terminal indicates that the terminal is on the first preset road section of the driving route comprises turning off, by the terminal, the screen of the terminal or adjusting the screen brightness of the terminal from the first screen brightness to the second screen brightness when the terminal determines that the location information of the terminal indicates a start location of the first preset road section.

4. The method according to claim 1, wherein the method further comprises turning on, by the terminal, the screen of the terminal or brightening the display according to the first screen brightness when the location information of the terminal indicates that the terminal is not in the first preset road section.

5. The method according to claim 4, wherein turning on, by the terminal, the screen of the terminal or brightening the display according to the first screen brightness when the location information of the terminal indicates that the terminal is not in the first preset road section comprises turning on, by the terminal, the screen of the terminal or brightening the display according to the first screen brightness when the terminal determines that the location information of the terminal is an end location of the first preset road section.

6. The method according to claim 1, wherein wherein the first preset road section is determined by the terminal according to a historical driving route and is preconfigured in the terminal, or.

7. The method according to claim 1, wherein before turning off, by the terminal, the screen of the terminal or adjusting the screen brightness of the terminal from the first screen brightness to the second screen brightness when the location information of the terminal indicates that the terminal is on the first preset road section of the driving route, further comprises:
receiving, by the terminal, a geographical location that is on the driving route and is entered by the user or sent by the navigation server and in which navigation requires to be started; and
starting, by the terminal, navigation when the terminal determines that the location information of the terminal is the geographical location in which navigation requires to be started.

8. A terminal, comprising:
a processor; and
a positioning chip coupled to the processor,
wherein the processor is configured to:
obtain start place information and destination information; and
obtain information about a driving route determined according to the start place information and the destination information,
wherein the positioning chip is configured to obtain location information of the terminal in a moving process of the terminal,
wherein the processor is further configured to turn off a screen of the terminal or adjust screen brightness of the terminal from first screen brightness to second screen brightness when the location information of the terminal obtained by the positioning chip indicates that the terminal is on a first preset road section of the driving route, and
wherein the first screen brightness is greater than the second screen brightness.

9. The terminal according to claim 8, wherein the terminal further comprises an audio processor coupled to the processor, and wherein the audio processor stops providing voice prompt when the processor turns off the screen of the terminal or adjusts the screen brightness of the terminal from the first screen brightness to the second screen brightness.

10. The terminal according to claim 8, wherein the processor is further configured to turn off the screen of the terminal or adjust the screen brightness of the terminal from the first screen brightness to the second screen brightness when determining that the location information of the terminal is a start location of the first preset road section.

11. The terminal according to claim 8, wherein the processor is further configured to turn on the screen of the terminal or brighten the display according to the first screen brightness when the location information of the terminal obtained by the positioning chip indicates that the terminal is not in the first preset road section.

12. The terminal according to claim 11, wherein the processor is further configured to turn on the screen of the terminal or brighten the display according to the first screen brightness when determining that the location information of the terminal is an end location of the first preset road section.

13. The terminal according to claim 8, wherein the first preset road section is determined by the terminal according to a historical driving route and is preconfigured in the terminal.

14. The terminal according to claim 8, wherein the terminal further comprises a receiver coupled to the processor, wherein the receiver is configured to, before the processor turns off the screen of the terminal or adjusts the screen brightness of the terminal from the first screen brightness to the second screen brightness, receive a geographical location that is on the driving route and is entered by the user or sent by the navigation server and in which navigation requires to be started, and wherein the processor is further configured to start navigation when determining that the location information of the terminal is the geographical location in which navigation requires to be started.

15. A navigation method, comprising:
obtaining, by a terminal, start place information and destination information;
obtaining, by the terminal, information about a driving route determined according to the start place information and the destination information;
obtaining, by the terminal, location information of the terminal in a moving process of the terminal; and
stopping, by the terminal, providing voice prompt when the location information of the terminal indicates that the terminal is on a first preset road section of the driving route.

16. The method according to claim 15, wherein the method further comprises adjusting, by the terminal, the screen brightness of the terminal from a first screen brightness to a second screen brightness.

17. The method according to claim 15, wherein the method further comprises providing, by the terminal, voice prompt when the location information of the terminal indicates that the terminal is not in the first preset road section.

18. The method according to claim 15, wherein the first preset road section is determined by the terminal according to a historical driving route and is preconfigured in the terminal.

19. The method according to claim 16, wherein before adjusting the screen brightness of the terminal from the first screen brightness to the second screen brightness, the method further comprises:
receiving, by the terminal, a geographical location that is on the driving route and is entered by the user or sent by the navigation server and in which navigation requires to be started; and
starting, by the terminal, navigation when the terminal determines that the location information of the terminal is the geographical location in which navigation requires to be started, or when the terminal passes through, in a moving direction of the terminal, the geographical location in which navigation requires to be started.
